(19) United States
(12) Patent Application Publication
(10) Pub. No.: US 2021/0064572 A1
(43) Pub. Date: Mar. 4, 2021

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJI XEROX CO., LTD., Tokyo (JP)

(72) Inventor: Yusaku OKADA, Kanagawa (JP)

(73) Assignee: FUJI XEROX CO., LTD., Tokyo (JP)

(21) Appl. No.: 16/829,450

(22) Filed: Mar. 25, 2020

(30) Foreign Application Priority Data
Aug. 28, 2019 (JP) 2019-155883

(51) Int. Cl. G06F 16/11; G06F 16/182

(52) U.S. Cl. CPC G06F 16/119; G06F 16/183

(57) ABSTRACT

An information processing apparatus includes a migration part, a detecting part, and an incorporating part. The migration part migrates a system by migrating one or more files at a migration source to a migration destination. The detecting part detects an edit of a file at the migration source. If the edit of the file at the migration source is detected by the detecting part while the system is being migrated by the migration part, the incorporating part incorporates edited content of the file at the migration source into the migration destination.

### CROSS-REFERENCE TO RELATED APPLICATIONS

This application is based on and claims priority under 35 USC 119 from Japanese Patent Application No. 2019-155883 filed Aug. 28, 2019.

### BACKGROUND

### (i) Technical Field

The present disclosure relates to an information processing apparatus, an information processing system, and a non-transitory computer readable medium storing a program.

### (ii) Related Art

Japanese Unexamined Patent Application Publication No. 2005-084963 proposes a file sharing device that includes data migrating means and access processing means. The data migrating means causes data retained in a file system of a migration source file sharing device to migrate to a file system of the file sharing device. The access processing means processes access from a host computer in correspondence to data migration statuses during the data migration processing. The access processing means provides data from the file system of the file sharing device in the case of access to data that can be used from the file system of the file sharing device and causes data to be provided from the file system of the migration source file sharing device in the case of access to data that cannot be used from the file system of the file sharing device.

Japanese Unexamined Patent Application Publication No. 2011-198071 proposes an application migration system that includes a personal computer and a migration management server. The personal computer identifies data that is necessary to execute each application installed on the personal computer, records the history of use of each application, reports the history to the migration management server, and transfers an application in accordance with a command received from the migration management server. The migration management server calculates the frequency of use of each application in accordance with the history of use of the application and sends a command to instruct the personal computer to transfer applications to another computer in order of priority based on the frequency.

### SUMMARY

Techniques and methods are available for sequentially migrating data items in order of priority or the frequency of use. However, no operation is allowed until the migration is complete. Further, if a data item at a migration source is allowed to be edited during system migration, edited content cannot be incorporated into a migration destination in a case where a data item being edited is not stored before being migrated or in a case where a data item at the migration source is edited after being migrated to the migration destination. Thus, aspects of non-limiting embodiments of the present disclosure relate to providing an information processing apparatus, an information processing system, and a non-transitory computer readable medium storing an information processing program that enable edited content to be incorporated into the migration destination if a data item at the migration source is edited during system migration.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a migration part, a detecting part, and an incorporating part. The migration part migrates a system by migrating one or more files at a migration source to a migration destination. The detecting part detects an edit of a file at the migration source. If the edit of the file at the migration source is detected by the detecting part while the system is being migrated by the migration part, the incorporating part incorporates edited content of the file at the migration source into the migration destination.

### BRIEF DESCRIPTION OF THE DRAWINGS

An exemplary embodiment of the present disclosure will be described in detail based on the following figures, wherein:

FIG. 1 is an illustration depicting a schematic configuration of an information processing system according to the present exemplary embodiment;

FIG. 2 is a block diagram depicting a configuration of major electrical components of each of an information processing terminal, a cloud server, and a server in the information processing system according to the present exemplary embodiment;

FIG. 3 is a block diagram depicting a functional configuration of the cloud server in the information processing system according to the present exemplary embodiment;

FIG. 4 is a diagram for illustrating an example in which edited content is incorporated into a migration-destination document management system when a file in a migration-source document management system completes migration after the file is checked out and before the file is checked in;

FIG. 5 is a diagram for illustrating an example in which edited content is incorporated into the migration-destination document management system when a file in the migration-source document management system, which corresponds to a file that has already been migrated to the migration-destination document management system, is checked out and edited during system migration;

FIG. 6 is a flowchart depicting an example flow of a process performed by a system migration service of the cloud server in the information processing system according to the present exemplary embodiment; and

FIG. 7 is a flowchart depicting an example flow of a process performed by the system migration service during migration of content data items of files from the migration-source document management system to the migration-destination document management system.

### DETAILED DESCRIPTION

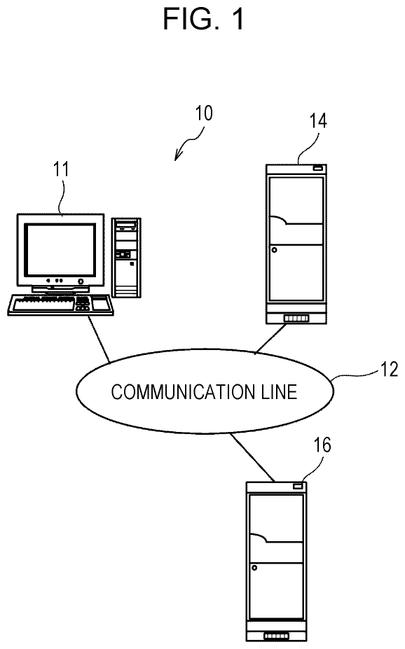

Hereinafter, an example in the present exemplary embodiment will be described in detail with reference to the drawings. In the present exemplary embodiment, an information processing system in which an information processing terminal and a plurality of servers are connected to each other via a communication line, such as various kinds of networks, will be described as an example. FIG. 1 is an illustration depicting a schematic configuration of an information processing system 10 according to the present exemplary embodiment.

The information processing system 10 according to the present exemplary embodiment includes an information processing terminal 11, a cloud server 14, which serves as an information processing apparatus, and a server 16, which serves as a migration-source manager, as depicted in FIG. 1. In the present exemplary embodiment, an example of the information processing system 10 that includes a single information processing terminal 11, a single cloud server 14, and a single server 16 is described, but the information processing system 10 may include one or more information processing terminals 11, one or more cloud servers 14, and one or more servers 16.

The information processing terminal 11, the cloud server 14, and the server 16 are connected to each other via a communication line 12, such as a local area network (LAN), a wide area network (WAN), the Internet, or an intranet. The information processing terminal 11, the cloud server 14, and the server 16 are capable of transmitting and receiving various kinds of data to and from each other via the communication line 12.

In the information processing system 10 according to the present exemplary embodiment, the cloud server 14 provides a system migration service and a document management service as a cloud service. The system migration service performs, for example, a process in which a system such as a document management system that is set up in the server 16 located on premises is migrated to a document management system provided by the cloud server 14 or to a different system such as the information processing terminal 11. In the present exemplary embodiment, system migration is described under the assumption that a system at a migration source is copied to a migration destination, but a system at a migration source may be migrated to a migration destination without retaining the system at the migration source.

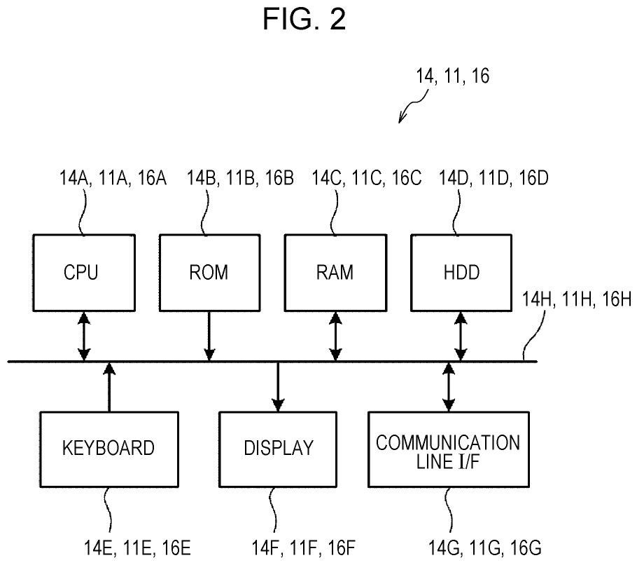

Next, a configuration of major electrical components of each of the information processing terminal 11, the cloud server 14, and the server 16 according to the present exemplary embodiment will be described. FIG. 2 is a block diagram depicting a configuration of major electrical components of each of the information processing terminal 11, the cloud server 14, and the server 16 in the information processing system 10 according to the present exemplary embodiment. The information processing terminal 11, the cloud server 14, and the server 16 each are basically designed to have a configuration of a general-purpose computer, and thus the cloud server 14 will be described as a representative example.

The cloud server 14 according to the present exemplary embodiment includes a central processing unit (CPU) 14A, a read-only memory (ROM) 14B, a random-access memory (RAM) 14C, a hard disk drive (HDD) 14D, a keyboard 14E, a display 14F, and a communication line interface (I/F) 14G, as depicted in FIG. 2. The CPU 14A manages the entire operation of the cloud server 14. The ROM 14B stores various control programs, various parameters, and the like in advance. The RAM 14C is used as a work area and the like while the CPU 14A executes various programs. The HDD 14D stores various kinds of data, application programs, and the like. The keyboard 14E is used for inputting various kinds of information. The display 14F is used for displaying various kinds of information. The communication line I/F 14G is connected to the communication line 12 and transmits and receives various kinds of data to and from other apparatuses connected to the communication line 12. All the above units in the cloud server 14 are electrically connected to each other via a system bus 14H. In the cloud server 14 according to the present exemplary embodiment, although the HDD 14D is adopted as a storage unit, this is not meant to be limiting, and a different nonvolatile storage unit, such as a flash memory, may be adopted.

In the above configuration of the cloud server 14 according to the present exemplary embodiment, the CPU 14A performs access to the ROM 14B, the RAM 14C, and the HDD 14D, acquisition of various kinds of data via the keyboard 14E, and display of various kinds of information on the display 14F. The cloud server 14 also controls by using the CPU 14A transmission and reception of communication data via the communication line I/F 14G.

In the information processing system 10 according to the present exemplary embodiment, the information processing system 10 being configured in this way, the cloud server 14 provides the system migration service and the document management service as a cloud service, as described above. A description will be given below, as an example, of a case where the system migration service migrates a migration-source document management system 17 that is set up in the server 16 to a document management service provided by the cloud server 14 (hereinafter referred to as a migration-destination document management system 18).

When files in a document management system are migrated, a known technique creates a complete copy and a differential copy of the entire system to migrate the system. However, while the complete copy of the entire system is being created, the system needs to be shut down. Further, the system shutdown period is sometimes prolonged in proportion to the amount of data. Thus, in the present exemplary embodiment, the file structure at a migration source and the identification information items each of which identifies a file at the migration source are copied to a migration destination before content data items of one or more files at the migration source are migrated. In this way, once the file structure and the identification information items are copied to the migration destination, the system at the migration destination is able to operate, and the system shutdown period is shortened compared with a case where the complete copy of the entire system is created.

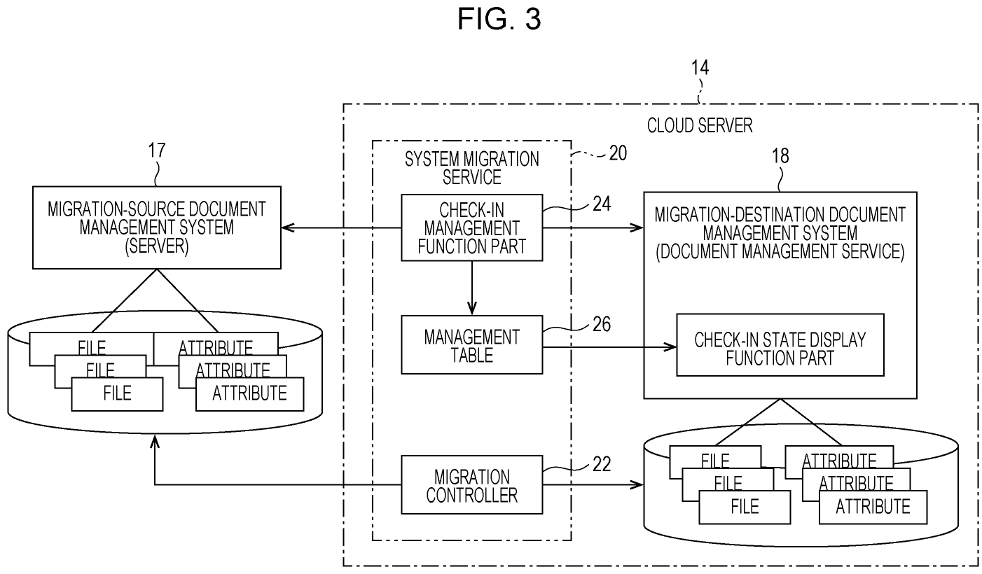

The information processing system 10 according to the present exemplary embodiment includes a function that, in response to an edit of a file performed at the migration source during system migration, incorporates into the migration destination a change in the file at the migration source. FIG. 3 is a block diagram depicting a functional configuration of the cloud server 14 in the information processing system 10 according to the present exemplary embodiment.

As described above, the information processing system 10 according to the present exemplary embodiment provides a system migration service 20 and the migration-destination document management system 18 as a cloud service.

The system migration service 20 migrates to the migration-destination document management system 18, which serves as a migration-destination manager, a plurality of files and attributes of the plurality of files, both of which are managed by the migration-source document management system 17, which serves as a migration-source manager, together with the file structure including a hierarchical structure of the files.

The system migration service 20 includes functions of a management table 26, a check-in management function part 24, which serves as a detecting part and an incorporating part, and a migration controller 22, which serves as a migration part, as depicted in FIG. 3.

The management table 26 monitors a check-out and a check-in of a file and manages a file being checked out in the migration-source document management system 17 and in the migration-destination document management system 18.

The check-in management function part 24 detects a check-out and a check-in in the migration-source document management system 17 and registers in the management table 26 the information regarding the check-in and the check-out. In addition, the check-in management function part 24 performs the processing of incorporating into the migration-destination document management system 18 the content changed while a file is being checked out, the processing being based on the information in the management table 26.

The migration controller 22 controls migration of files to be migrated from the migration-source document management system 17 to the migration-destination document management system 18. In the present exemplary embodiment, the file structure at the migration source, which includes a hierarchy of files and a tree structure, and the identification information items each of which is used for identifying a file are acquired from the migration-source document management system 17, and the file structure and the identification information items are copied to the migration-destination document management system 18 before content data items of the files are migrated. The migration controller 22 also migrates the system by sequentially copying content data items of the files in the migration-source document management system 17 to corresponding locations of the file structure and the identification information items, which have been copied. Attribute information items of the files may also be acquired simultaneously and copied to the migration-destination document management system 18 when the file structure and the identification information items are copied to the migration-destination document management system 18. Examples of the attribute information items include a registration date, an access date, a drawing number, a file type, and a document type.

A description will be given of a process performed by the check-in management function part 24, the process being performed when a file in the migration-source document management system 17 is checked out and edited during system migration.

The check-in management function part 24 detects a check-out when a file in the migration-source document management system 17 is checked out while content data items of files are sequentially migrated after the file structure and the identification information items of the migration-source document management system 17 have been copied to the migration-destination document management system 18.

If the checked-out file has not been migrated to the migration-destination document management system 18 yet and is not migrated until the check-in, the file is migrated after being checked in into the migration-source document management system 17. Thus, the file is migrated to the migration-destination document management system 18 with the edited content incorporated.

However, if the checked-out file is a file that has been migrated to the migration-destination document management system 18 or if a target file is migrated while being checked out, the target file is present in both the migration-source document management system 17 and the migration-destination document management system 18. While a check-in enables edited content to be incorporated into the target file in the migration-source document management system 17, the check-in into the migration-source document management system 17 at this time does not incorporate the edited content into the migration-destination document management system 18 because the target file has already been migrated. Thus, if the target file is present in both systems, the check-in management function part 24 checks out the target file in the migration-destination document management system 18, incorporates the edited content into the target file, and checks in the target file into the migration-destination document management system 18. In this way, if a file in the migration-source document management system 17 is checked out and edited, the edited content is incorporated into the file in the migration-destination document management system 18.

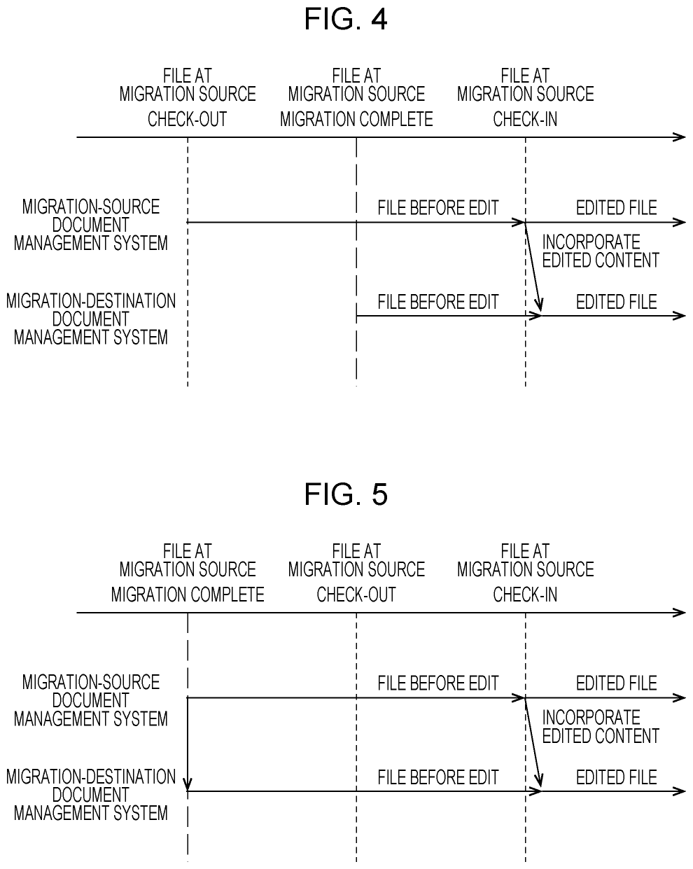

For example, as depicted in FIG. 4, if a file in the migration-source document management system 17 completes migration after the file is checked out and before the file is checked in, edited content is not incorporated into the file in the migration-destination document management system 18. Thus, upon detecting a checked-out file being checked in into the migration-source document management system 17, the check-in management function part 24 checks out the file migrated to the migration-destination document management system 18, incorporates the edited content into the file, and checks in the edited file into the migration-destination document management system 18.

Further, as depicted in FIG. 5, if a file in the migration-source document management system 17 that corresponds to a file migrated to the migration-destination document management system 18 is checked out and edited during system migration, edited content is not incorporated into the file in the migration-destination document management system 18. Thus, upon detecting a file being checked out in the migration-source document management system 17, the check-in management function part 24 checks out the corresponding file in the migration-destination document management system 18. Then, upon detecting the file being checked in into the migration-source document management system 17, the check-in management function part 24 incorporates the edited content into the file checked out from the migration-destination document management system 18 and checks in the edited file into the migration-destination document management system 18.

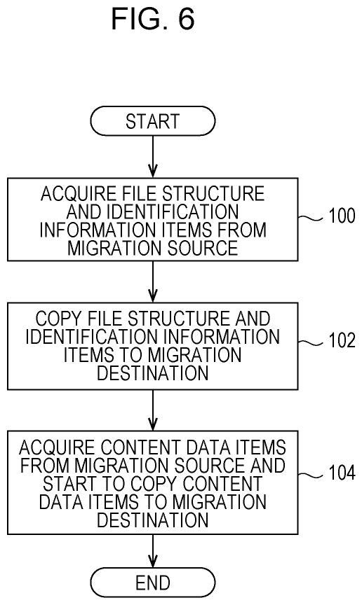

Next, a description will be given of a process performed by the cloud server 14 in the information processing system 10 according to the present exemplary embodiment, the information processing system 10 being configured as described above. FIG. 6 is a flowchart depicting an example flow of a process performed by the system migration service 20 of the cloud server 14 in the information processing system 10 according to the present exemplary embodiment. The process depicted in FIG. 6 starts when instructions to perform migration from the migration-source document management system 17 to the migration-destination document management system 18 are provided.

In step 100, the migration controller 22 acquires from the migration-source document management system 17 the file structure and the identification information items each of which is used for identifying a file, and the process proceeds to step 102. Step 100 corresponds to an operation performed by the acquiring part.

In step 102, the migration controller 22 copies to the migration-destination document management system 18 the file structure and the identification information items, which have been acquired, and the process proceeds to step 104. Once the file structure and the identification information items are copied to the migration-destination document management system 18, the file structure and the identification information items are viewable, and thus the migration-destination document management system 18 is able to operate. Step 102 corresponds to an operation performed by the copying part.

In step 104, the migration controller 22 acquires content data items of files from the migration-source document management system 17 and starts to sequentially copy the content data items to the migration-destination document management system 18, and a series of procedures is finished. Step 104 corresponds to an operation performed by a data acquiring part.

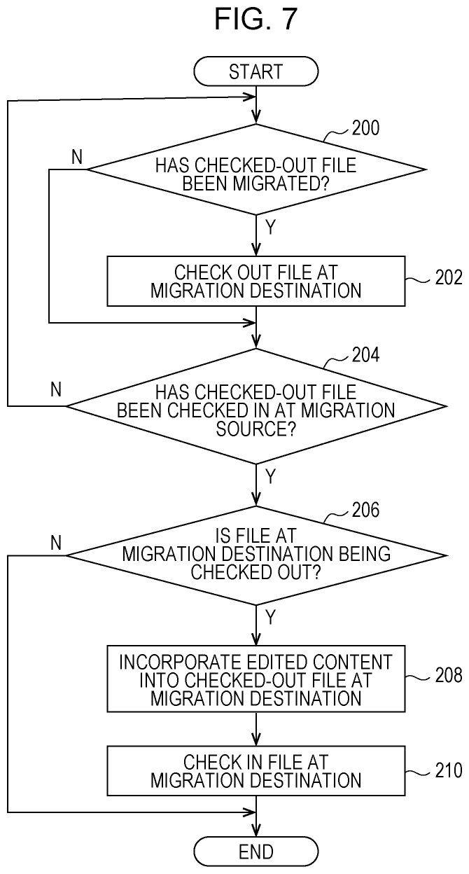

Next, a description will be given of a process performed by the system migration service 20 during migration of content data items of files from the migration-source document management system 17 to the migration-destination document management system 18. FIG. 7 is a flowchart depicting an example flow of a process performed by the system migration service 20 during migration of content data items of files from the migration-source document management system 17 to the migration-destination document management system 18. The process depicted in FIG. 7 starts when the check-in management function part 24 detects a check-out in the migration-source document management system 17.

In step 200, the check-in management function part 24 determines whether a checked-out file has already been migrated to the migration-destination document management system 18. If an affirmative determination is made in step 200, the process proceeds to step 202. If a negative determination is made in step 200, the process proceeds to step 204.

In step 202, the check-in management function part 24 checks out in the migration-destination document management system 18 the file corresponding to the checked-out file in the migration-source document management system 17, and the process proceeds to step 204.

In step 204, the check-in management function part 24 determines whether the checked-out file in the migration-source document management system 17 has been checked in. If an affirmative determination is made in step 204, the process proceeds to step 206. If a negative determination is made in step 204, the process returns to step 200 and repeats the above procedure.

In step 206, the check-in management function part 24 determines whether the file in the migration-destination document management system 18 is being checked out by the procedure in step 202. If an affirmative determination is made in step 206, the process proceeds to step 208. If a negative determination is made in step 206, a series of procedures is finished.

In step 208, the check-in management function part 24 incorporates edited content into the file checked out from the migration-destination document management system 18, and the process proceeds to step 210.

In step 210, the check-in management function part 24 checks in the file to which the edited content is incorporated, and a series of procedures is finished.

In the above exemplary embodiment, content data items of files are sequentially copied after a file structure and identification information items are copied to the migration destination, but this is not meant to be limiting. For example, a system may be adopted in which only identification information items, such as file names, are copied to the migration destination without a file structure being copied to the migration destination before content data items of files are migrated and thereafter the file structure and the content data items of files are sequentially copied. Alternatively, a system may be adopted in which files including a file structure, one or more identification information items, and one or more content data items are sequentially copied irrespective of the file type.

The system migration from the server 16 to the cloud server 14 is described as an example in the above exemplary embodiment, but this is not meant to be limiting. For example, the above exemplary embodiment may be applied to a system migration between two of the servers 16 on premises or to a system migration between two of the cloud servers 14.

The process performed by the cloud server 14 according to the above exemplary embodiment may be a process performed by using software, a process performed by using hardware, or a process performed by using a combination of software and hardware. The process performed by the cloud server 14 may be stored in a recording medium as a program and distributed by using the recording medium.

The present disclosure is not limited to the above exemplary embodiment, and various modifications other than the above exemplary embodiment may obviously be practiced as long as they do not depart from the spirit of the disclosure.

The foregoing description of the exemplary embodiment of the present disclosure has been provided for the purposes of illustration and description. It is not intended to be exhaustive or to limit the disclosure to the precise forms disclosed. Obviously, many modifications and variations will be apparent to practitioners skilled in the art. The embodiment was chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a migration part that migrates a system by migrating one or more files at a migration source to a migration destination;
a detecting part that detects an edit of a file at the migration source; and
an incorporating part that, if the edit of the file at the migration source is detected by the detecting part while the system is being migrated by the migration part, incorporates edited content of the file at the migration source into the migration destination.

2. The information processing apparatus according to claim 1,
wherein if the file that undergoes the edit at the migration source is present at the migration destination, the incorporating part incorporates the edited content of the file at the migration source into the migration destination.

3. The information processing apparatus according to claim 1,
wherein if the file that undergoes the edit at the migration source is not present at the migration destination, the incorporating part stores at the migration source the file that has undergone the edit and thereafter the migration part migrates the file that has undergone the edit to the migration destination.

4. The information processing apparatus according to claim 2,
wherein if the file that undergoes the edit at the migration source is not present at the migration destination, the incorporating part stores at the migration source the file that has undergone the edit and thereafter the migration part migrates the file that has undergone the edit to the migration destination.

5. The information processing apparatus according to claim 1,
wherein if the file that undergoes the edit is migrated to the migration destination during a process of being edited and before being stored while the system is being migrated, the incorporating part incorporates the edited content at the migration source into the migration destination.

6. The information processing apparatus according to claim 1,
wherein if a file that has been migrated is edited at the migration source while the system is being migrated, the incorporating part incorporates the edited content at the migration source into the migration destination.

7. The information processing apparatus according to claim 2,
wherein if the edit of the file at the migration source is detected by the detecting part, the incorporating part reads a corresponding file at the migration destination, and if the file at the migration source has been edited and stored at the migration source, the incorporating part incorporates the edited content into the corresponding file at the migration destination and stores the corresponding file at the migration destination.

8. The information processing apparatus according to claim 5,
wherein if the edit of the file at the migration source is detected by the detecting part, the incorporating part reads a corresponding file at the migration destination, and if the file at the migration source has been edited and stored at the migration source, the incorporating part incorporates the edited content into the corresponding file at the migration destination and stores the corresponding file at the migration destination.

9. The information processing apparatus according to claim 6,
wherein if the edit of the file at the migration source is detected by the detecting part, the incorporating part reads a corresponding file at the migration destination, and if the file at the migration source has been edited and stored at the migration source, the incorporating part incorporates the edited content into the corresponding file at the migration destination and stores the corresponding file at the migration destination.

10. The information processing apparatus according to claim 1,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

11. The information processing apparatus according to claim 2,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

12. The information processing apparatus according to claim 3,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

13. The information processing apparatus according to claim 4,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

14. The information processing apparatus according to claim 5,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

15. The information processing apparatus according to claim 6,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

16. The information processing apparatus according to claim 7,
wherein the migration part includes
an acquiring part that acquires a file structure at the migration source and one or more identification information items each of which identifies a file at the migration source,
a copying part that copies the file structure and the one or more identification information items to the migration destination before migration of content data items of the one or more files at the migration source, and
a data acquiring part that acquires a content data item of a file at the migration source, and
wherein the migration part migrates the content data item to a corresponding location of the file structure, the content data item being acquired by the data acquiring part, the file structure being copied to the migration destination by the copying part.

17. The information processing apparatus according to claim 1, further comprising:
a migration-destination manager that serves as the migration destination and that manages a plurality of files.

18. The information processing apparatus according to claim 2, further comprising:
a migration-destination manager that serves as the migration destination and that manages a plurality of files.

19. An information processing system comprising:
the information processing apparatus according to claim 1; and
a migration-source manager that serves as the migration source and that manages a plurality of files to be migrated.

20. A non-transitory computer readable medium storing a program causing a computer to execute a process for information processing, the process comprising:
migrating a system by migrating one or more files at a migration source to a migration destination;
detecting an edit of a file at the migration source; and
if the edit of the file at the migration source is detected while the system is being migrated, incorporating edited content of the file at the migration source into the migration destination.
